(19) United States
(12) Patent Application Publication
(10) Pub. No.: US 2006/0012081 A1
(43) Pub. Date: Jan. 19, 2006

(54) Custom prototyping

(76) Inventors: Bran Ferren, Beverly Hills, CA (US); Edward K.Y. Jung, Bellevue, WA (US); Clarence T. Tegreene, Bellevue, WA (US)

Correspondence Address: Clarence T. Tegreene, Esq.;Searete LLC, Suite 110, 1756-114th Ave. S.E., Bellevue, WA, 98004, US

(21) Appl. No.: 10/892,755

(22) Filed: Jul. 16, 2004

(51) Int. Cl. B29C 35/04; G06G 7/48

(52) U.S. Cl. 264/401; 703/9; 703/6; 710/1

(57) ABSTRACT

A method for producing an item data set representing the three-dimensional configuration of an item includes accepting a first input data set, the first input data set including first data representing at least a first three-dimensional configuration of a first three-dimensional object; accepting a second input data set, the second input data set including second data representing at least a second three-dimensional configuration of a second three-dimensional object; adapting one or both of the first data input set and the second data input set to be combined to obtain an item data set representing a three-dimensional configuration of the item; and combining the first input data set and the second input data set to obtain the item data set. Other methods and systems for producing item data sets and items.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s); the present application also claims the earliest available effective filing date(s) from, and also incorporates by reference in its entirety all subject matter of any and all parent, grandparent, great-grandparent, etc. applications of the following listed application(s):
1. U.S. patent application entitled EMBEDDED IDENTIFIERS, naming Bran Ferren, Edward K. Y. Jung and Clarence T. Tegreene as inventors, filed 16 Mar. 2004 having U.S. patent application Ser. No. 10/802,106.
2. U.S. patent application entitled A SYSTEM FOR MAKING CUSTOM PROTOTYPES, naming Edward K. Y. Jung, Bran Ferren and Clarence T. Tegreene as inventors, filed 2 Jul. 2004.
3. U.S. patent application entitled PERSONALIZED PROTOTYPING, naming Edward K. Y. Jung, Bran Ferren and Clarence T. Tegreene as inventors, filed contemporaneously herewith.

### FIELD OF THE INVENTION

The subject matter of this application generally relates to creating custom data sets and custom-made articles of manufacture.

### SUMMARY OF THE INVENTION

One embodiment of the subject matter of this application, a method for producing an item data set representing the three-dimensional configuration of an item, includes accepting a first input data set, the first input data set including first data representing at least a first three-dimensional configuration of a first three-dimensional object; accepting a second input data set, the second input data set including second data representing at least a second three-dimensional configuration of a second three-dimensional object; adapting one or both of the first data input set and the second data input set to be combined to obtain an item data set representing a three-dimensional configuration of the item; and combining the first input data set and the second input data set to obtain the item data set.

Another embodiment, a method for producing an item data set representing the three-dimensional configuration of an item, includes providing a first input data set from a first provider, the first input data set including first data representing at least a first three-dimensional configuration of a first three-dimensional object; accepting the first input data set; providing a second input data set from a second provider, the second input data set including second data representing at least a second three-dimensional configuration of a second three-dimensional object; accepting the second input data set; adapting the first data input set and the second data input set to be combined to obtain an item data set representing at least a three-dimensional configuration of the item; and combining the first input data set and the second input data set to obtain the item data set. The first provider and the second provider may be the same person or entity, and the either or both of the first provider and the second provider may be a customer of a business using the method or making the method available for use by a customer.

Other embodiments are described in the detailed description of the figures.

### BRIEF DESCRIPTION OF THE DRAWINGS

FIG. 1 is a flow chart depicting an embodiment of the subject matter of this application;

FIG. 2 is a flow chart depicting another embodiment of the subject matter of this application;

FIG. 3 is a flow chart depicting another embodiment;

FIG. 4 is a flow chart depicting another embodiment;

FIG. 5 is a flow chart depicting another embodiment;

FIG. 6 is a flow chart depicting another embodiment;

FIG. 7 is a flow chart depicting another embodiment;

FIG. 8 is a flow chart depicting another embodiment;

FIG. 9 is a flow chart depicting another embodiment;

FIG. 10 is a schematic diagram depicting other embodiments; and

FIG. 11 is a schematic depicting other embodiments.

### DETAILED DESCRIPTION OF THE FIGURES

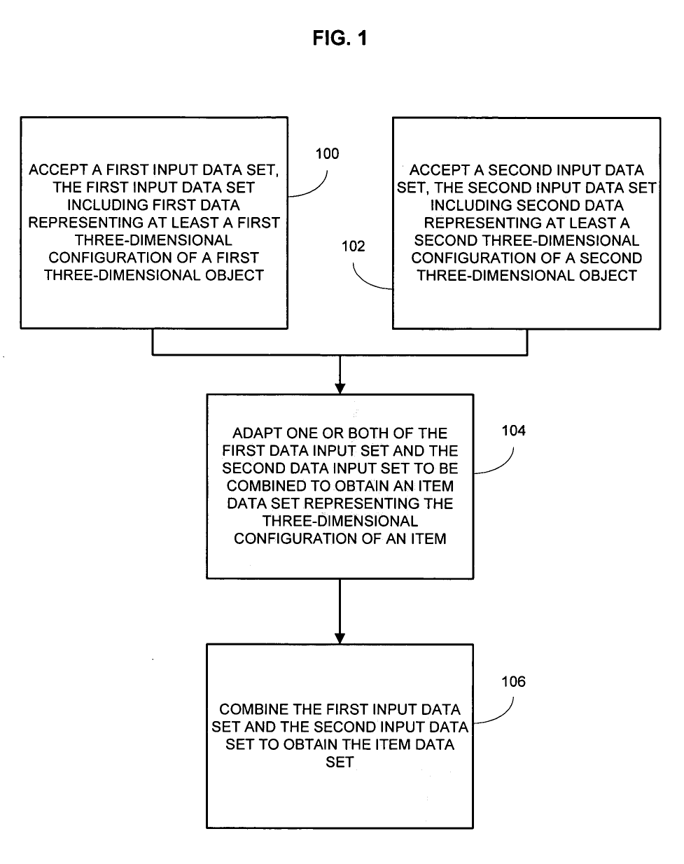

FIG. 1 shows an embodiment of the subject matter of this application, a method for producing an item data set representing the three-dimensional configuration of an item, the method including accepting a first input data set, the first input data set including first data representing at least a first three-dimensional configuration of a first three-dimensional object (step 100); accepting a second input data set, the second input data set including second data representing at least a second three-dimensional configuration of a second three-dimensional object (step 102); adapting one or both of the first data input set and the second data input set to be combined to obtain an item data set representing a three-dimensional configuration of the item (step 104); and combining the first input data set and the second input data set to obtain the item data set (step 106). Steps 100 and 102 may be performed in any order or simultaneously.

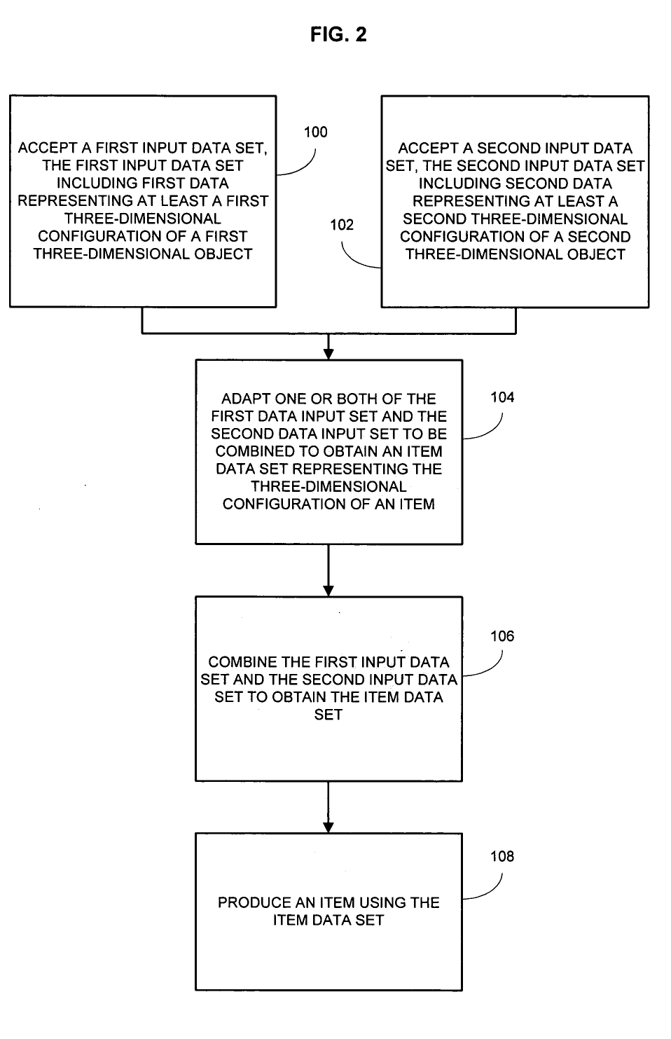

As shown in FIG. 2, another embodiment includes steps 100, 102, 104 and 106, and further includes producing the item using the item data set (step 108). This embodiment is not limited to any particular manufacturing process; the manufacturing processes include those generally known as rapid prototyping.

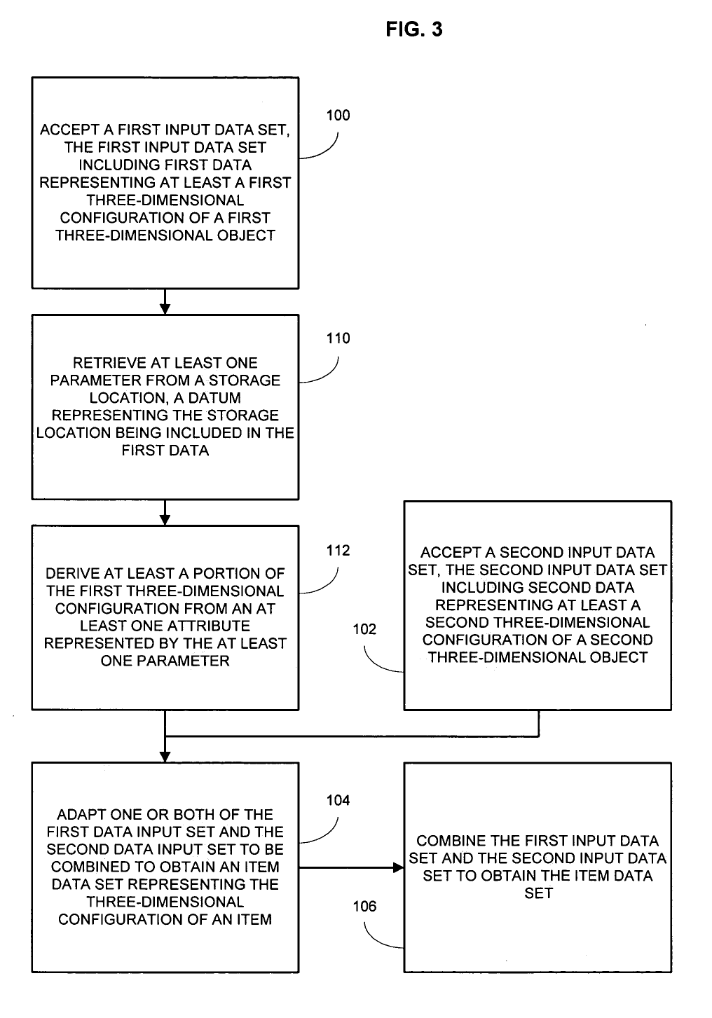

In another embodiment, at least a portion of the first data directly represents the first three-dimensional configuration, e.g., the first data includes spatial coordinates of the contours of the first three-dimensional configuration. In yet another embodiment, illustrated in FIG. 3, the first data includes at least one parameter representing at least one attribute of the first three-dimensional configuration, and further including deriving the first three dimensional configuration from the at least one attribute. In this embodiment, a parameter may be a numerical representation of an attribute, where an attribute may be a dimension, a feature, or, more generally, some describable aspect of a three-dimensional object.

The first data may include a datum representing a storage location, e.g., in a memory, for such a parameter, and an embodiment further includes retrieving the at least one parameter from the storage location using the at least one datum (step 110) and deriving the first three-dimensional configuration from the at least one attribute (step 112).

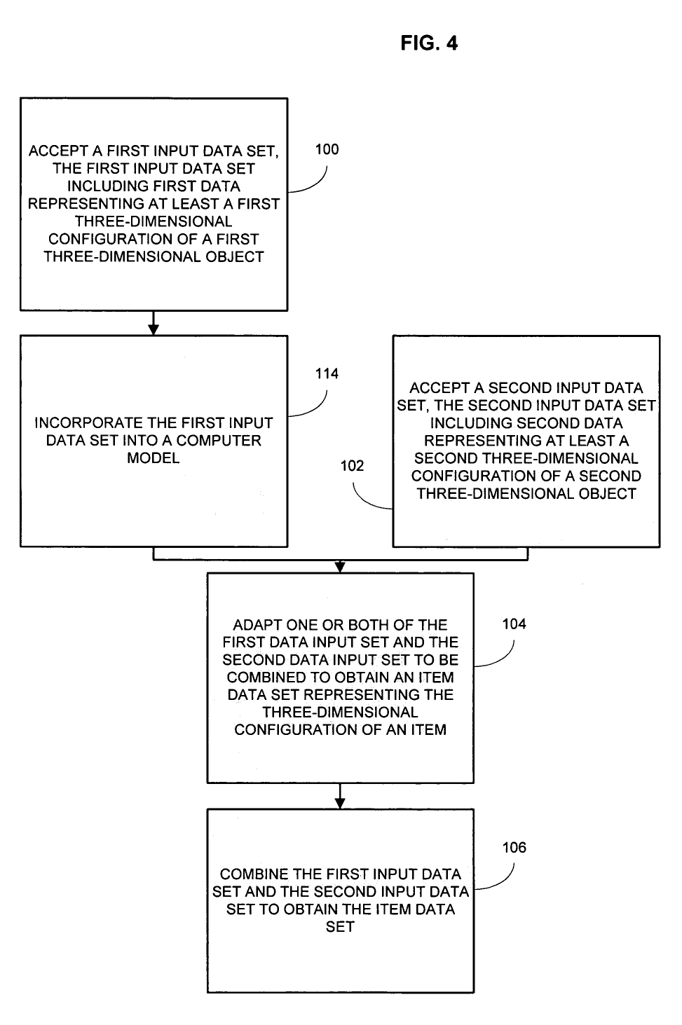

As shown in FIG. 4, one embodiment includes steps 100, 102, 104 and 106, and further includes incorporating at least a portion of the first input data set into a computer model (step 114). Herein, a “computer model” is a collection of attributes as discussed above, storable in an electronic library, memory, database, and including or capable of generating any interpolations required to make mutually compatible the attributes included in the computer model. A variety of computer models are known to skilled artisans.

In one embodiment, the first input data set includes transaction data, e.g., data including the details of a commercial transaction such as price. The transaction information may include billing information. In an embodiment, the first input data set includes identification data. The transaction information may include authorization information, e.g., information, encoded or otherwise, that has the effect of authorizing the completion of a transaction.

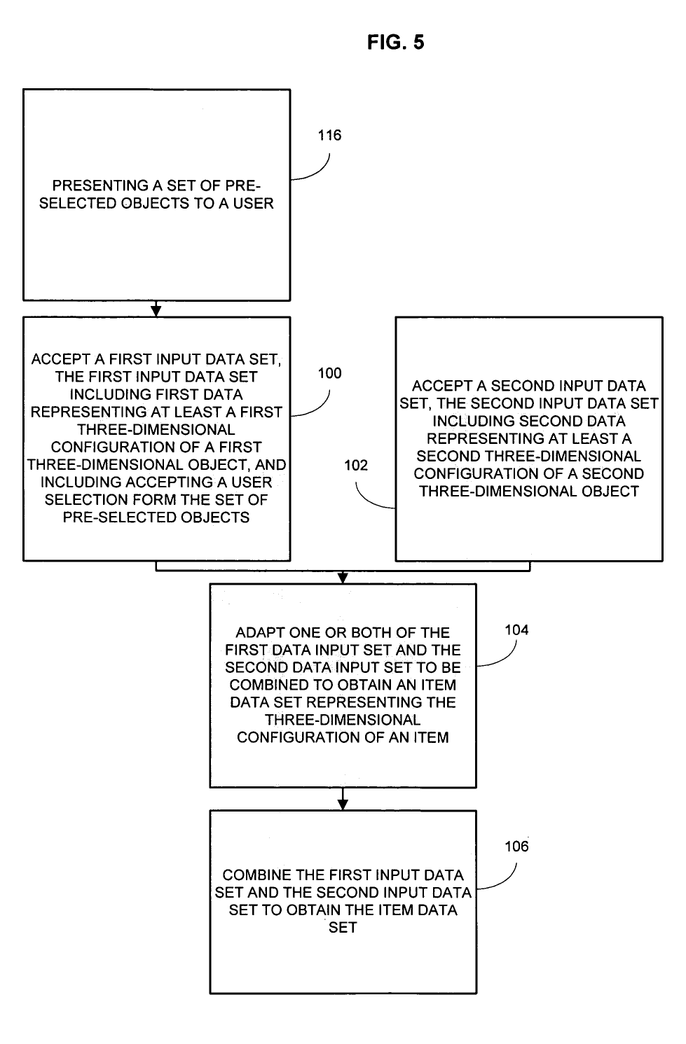

Another embodiment, shown in FIG. 5, including steps 100, 102, 106 and 108 further includes presenting a set of pre-selected objects to a user (step 116), and in this embodiment, step 100 includes accepting a user selection from the set of pre-selected objects. In one approach, presenting a set of pre-selected objects may include an interactive process with a user. For example, a user interface may present a set of categories from which the user may elect one or more. The user interface may then present a set of visual images, e.g., thumbnails or full-size images from which the user can select objects.

Various embodiments including steps 100, 102, 104 and 106 may include one or more steps and features, described here for illustrative purposes in detail in conjunction with first input data set or the first data, with regard to one or both of the second input data set or the second data.

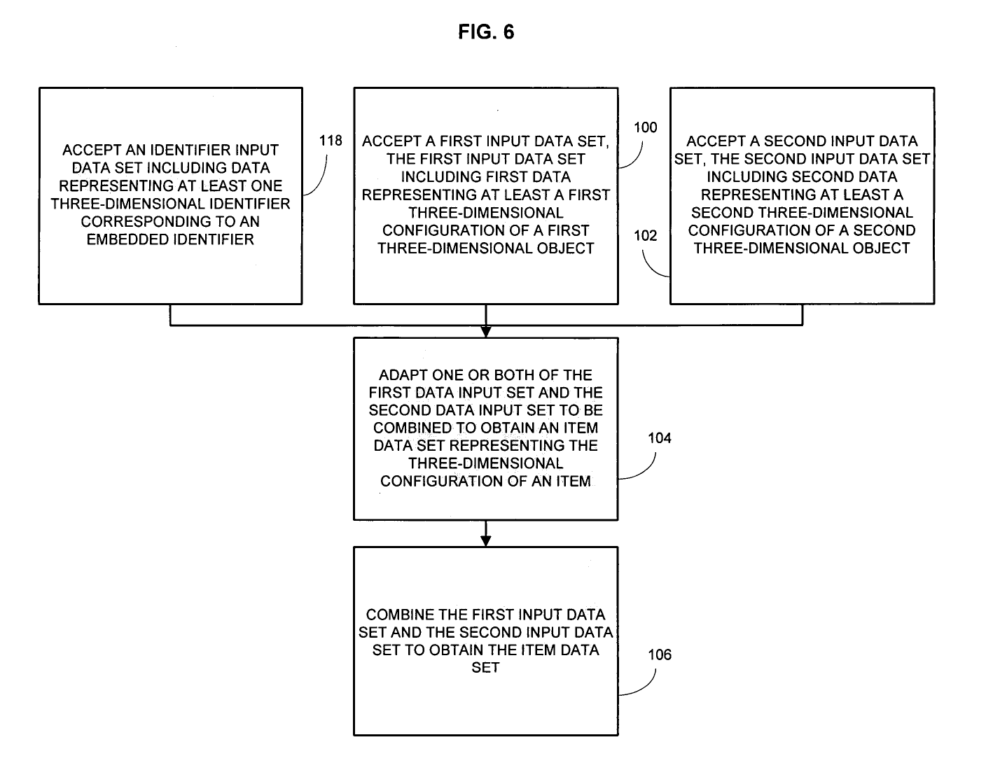

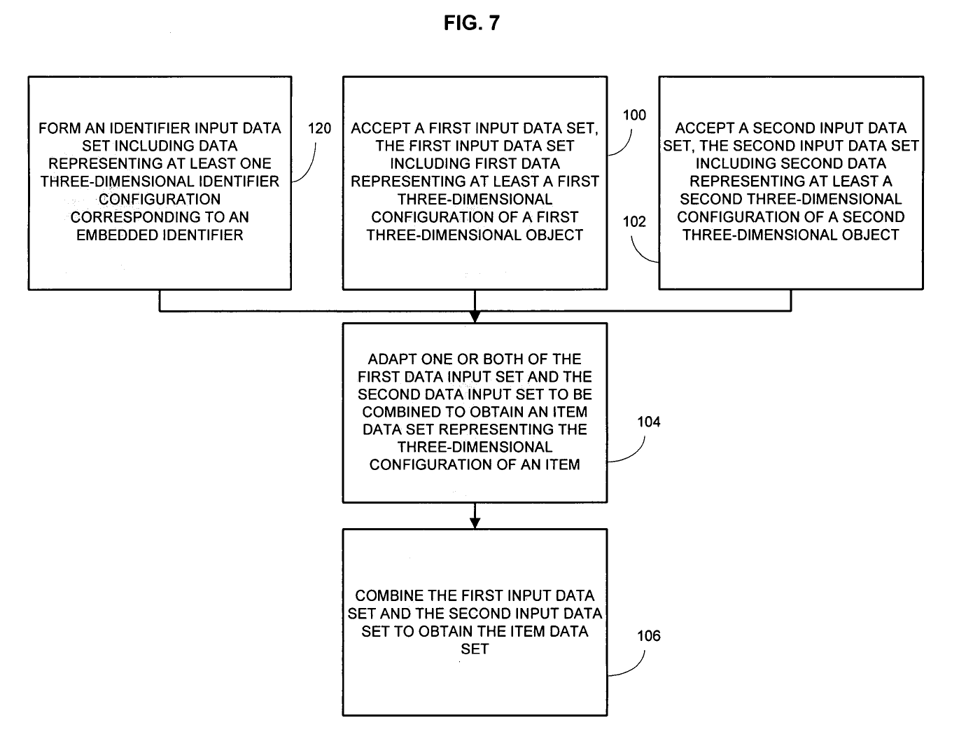

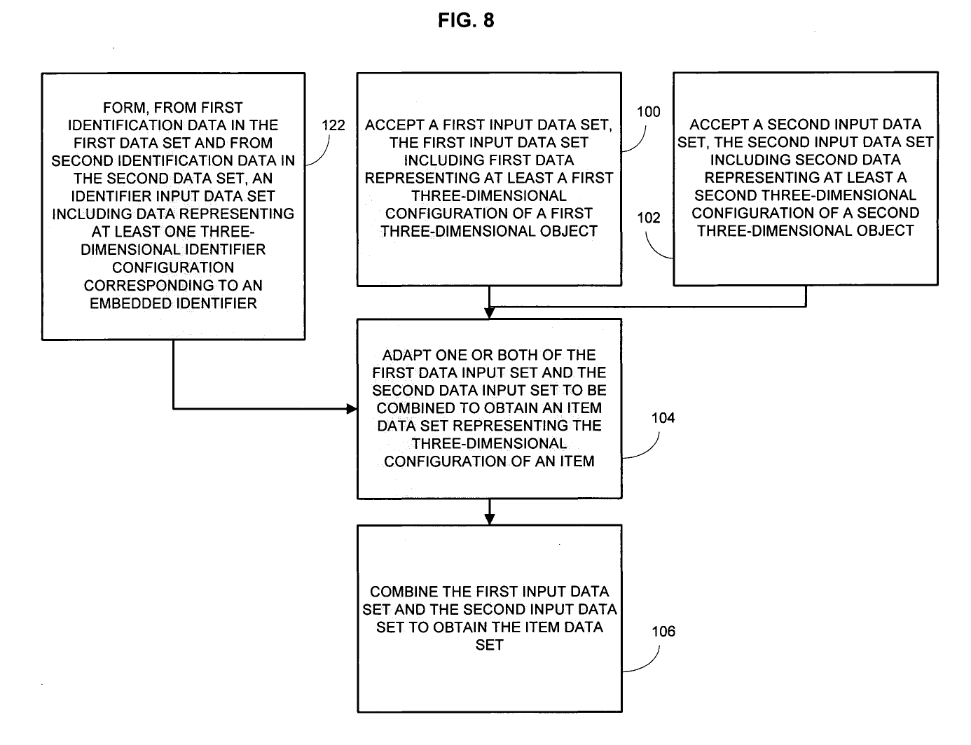

FIG. 6 illustrates another embodiment including steps 100, 102, 106 and 108 which further includes accepting an identifier input data set including data representing at least one three-dimensional identifier configuration corresponding to an embedded identifier (step 118). Embedded identifiers are discussed in U.S. patent application Ser. No. 10/802,106, filed Mar. 16, 2004. As shown in FIG. 7, yet another embodiment including steps 100, 102, 106 and 108 further includes forming an identifier input data set including data representing at least one three-dimensional identifier configuration corresponding to an embedded identifier (step 120). As illustrated in FIG. 8, still another embodiment including steps 100, 102, 106 and 108 further includes forming from first identification data and second identification data an identifier input data set including data representing at least one three-dimensional identifier configuration corresponding to an embedded identifier, where the first input data set includes the first identification data and the second input data set includes the second identification data (step 122).

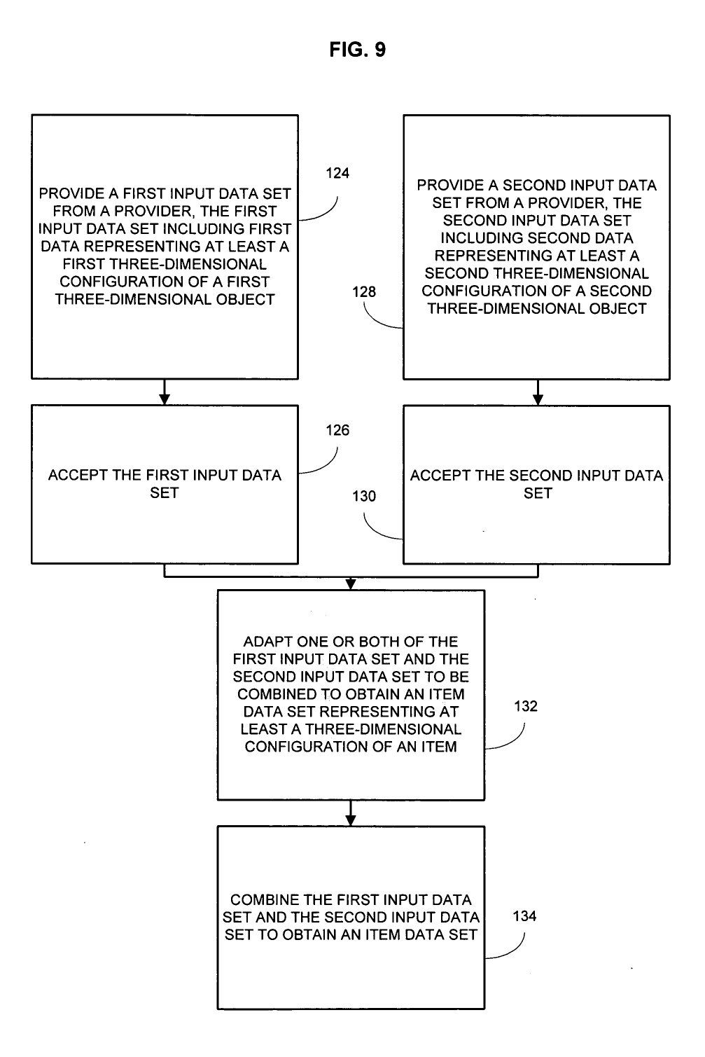

FIG. 9 illustrates one embodiment, a method for producing an item data set representing the three-dimensional configuration of an item, which includes providing a first input data set from a first provider, the first input data set including first data representing at least a first three-dimensional configuration of a first three-dimensional object (step 124); accepting the first input data set (step 126); providing a second input data set from a second provider, the second input data set including second data representing at least a second three-dimensional configuration of a second three-dimensional object (step 128); accepting the second input data set (step 130); adapting the first data input set and the second data input set to be combined to obtain an item data set representing at least a three-dimensional configuration of the item (step 132); and combining the first input data set and the second input data set to obtain the item data set (step 134). Steps 124 and 126, taken together, may be performed before, after, simultaneously with, or partially simultaneously with steps 128 and 130 taken together. The first provider and the second provider may be the same person or entity, and the either or both of the first provider and the second provider may be a customer of a business using the method or making the method available for use by a customer. In one example, the first provider may be a customer who may be located remotely from the business, may be at the location of the business, or may be located at a designated input location, such as a kiosk.

In one alternative, a user interface may present to the user a representation of the three-dimensional configuration of the item and provide a set of options to the user. For example, the user may approve of the item or may elect to modify one or more portions of the item. If the user elects to modify the item, the user interface may then provide updated financial transaction and scheduling information to the user and may permit additional user input such as transaction approval.

Generally, in the figures herein, where two or more parallel branches of a flow chart are shown, the steps on any of the parallel branches may be performed before, after, simultaneously with, or partially simultaneously with the steps on the other branch or branches.

Various embodiments including steps 124, 126, 128, 130, 132 and 134 may include one or more of the steps and features discussed above in conjunction with steps 100, 102, 104 and 106.

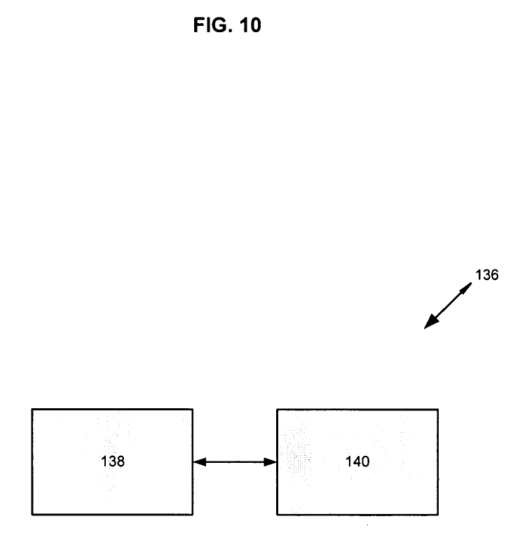

FIG. 10 shows an embodiment, a system 136 for producing an item data set representing the three-dimensional configuration of an item, including a processor 138; a memory 140 operably coupled to the processor 138; and software stored in the memory 140 and adapted to accept a first input data set, the first input data set including data representing a first three-dimensional configuration of a first three-dimensional object; to accept a second input data set, the second input data set including data representing a second three-dimensional configuration of a second three-dimensional object; to adapt one or both of the first data input set and the second data input set to be combined to obtain an item data set representing a three-dimensional configuration of an item, the item including at least one first feature of the first three-dimensional object and at least one second feature of the second three-dimensional object; and to combine the first input data set and the second input data set to obtain the item data set.

FIG. 10 also serves to show another embodiment, a system 136 for producing an item data set representing the three-dimensional configuration of an item. The system 136 includes a processor 138; a memory 140 operably coupled to the processor 138; and software stored in the memory 140 and adapted to provide a first input data set from a first provider, the first input data set including first data representing at least a first three-dimensional configuration of a first three-dimensional object; to accept the first input data set; to provide a second input data set from a second provider, the second input data set including second data representing at least a second three-dimensional configuration of a second three-dimensional object; to accept the second input data set; to adapt the first data input set and the second data input set to be combined to obtain an item data set representing at least a three-dimensional configuration of the item; and to combine the first input data set and the second input data set to obtain the item data set.

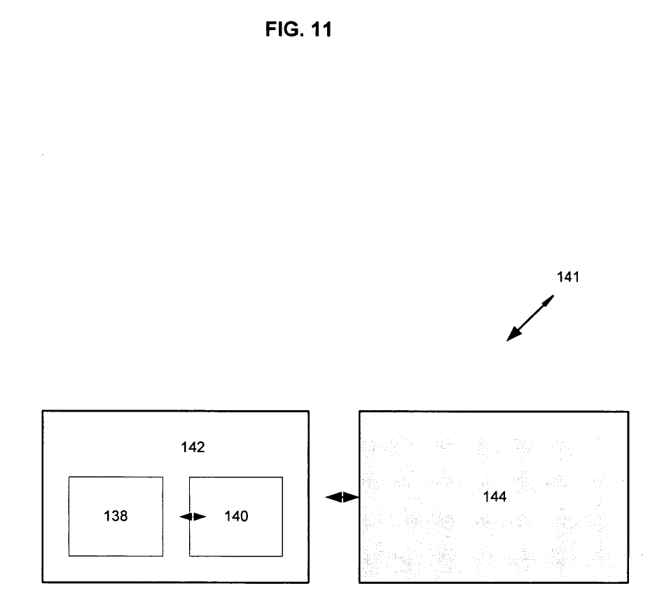

FIG. 11 illustrates an embodiment, a system 141 for producing an item which includes a computer 142 including a processor 138 and a memory 140 operably coupled to the processor 138; the computer 142 programmed to accept a first input data set, the first input data set including data representing a first three-dimensional configuration of a first three-dimensional object; to accept a second input data set, the second input data set including data representing a second three-dimensional configuration of a second three-dimensional object; to adapt one or both of the first data input set and the second data input set to be combined to obtain an item data set representing a three-dimensional configuration of an item, the item including at least one first feature of the first three-dimensional object and at least one second feature of the second three-dimensional object; and to combine the first input data set and the second input data set to obtain the item data set; and a fabrication apparatus 144 operably coupled to the computer and programmed to use the item data set to produce the item. The fabrication apparatus may be a rapid prototyping apparatus.

FIG. 11 also illustrates another embodiment, a system 141 for producing an item including a computer 142 including a processor 138 and a memory 140 operably coupled to the processor 138, the computer 142 programmed to provide a first input data set from a first provider, the first input data set including first data representing at least a first three-dimensional configuration of a first three-dimensional object; to accept the first input data set; to provide a second input data set from a second provider, the second input data set including second data representing at least a second three-dimensional configuration of a second three-dimensional object; to accept the second input data set; to adapt the first data input set and the second data input set to be combined to obtain an item data set representing at least a three-dimensional configuration of the item; and to combine the first input data set and the second input data set to obtain the item data set; and a fabrication apparatus 144 operably coupled to the computer 142 and programmed to use the combined data set to produce the item. The fabrication apparatus may be a rapid prototyping apparatus.

One skilled in the art will recognize that the foregoing components (e.g., steps), devices, and objects in FIGS. 1-11 and the discussion accompanying them are used as examples for the sake of conceptual clarity and that various configuration modifications are common. Consequently, as used herein, the specific exemplars set forth in FIGS. 1-11 and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

While particular embodiments of the subject matter of this application have been shown and described, it will be obvious to those skilled in the art that, based upon the teaching herein, changes and modifications may be made without departing from the subject matter and its broader aspects and, therefore, the appended claims are to encompass within their scope all such changes and modifications as are within the true spirit and scope of the subject matter. Furthermore, it is to be understood that the subject matter of this application is solely defined by the appended claims.

Other embodiments are within the following claims.

We claim:

1. A method for producing an item data set representing a three-dimensional configuration of an item, the method comprising:
accepting a first input data set, the first input data set including first data representing at least a first three-dimensional configuration of a first three-dimensional object;
accepting a second input data set, the second input data set including second data representing at least a second three-dimensional configuration of a second three-dimensional object;
adapting one or both of the first data input set and the second data input set to be combined to obtain an item data set representing the three-dimensional configuration of the item; and
combining the first input data set and the second input data set to obtain the item data set.

2. A method for producing an item, the method comprising:
the method of claim 1 and further comprising producing the item using the item data set.

3. The method of claim 2, wherein the producing the item uses rapid prototyping.

4. The method of claim 1, wherein at least a portion of the first data directly represents the first three-dimensional configuration.

5. The method of claim 1, wherein at least a portion of the first data includes at least one parameter representing at least one attribute of the first three-dimensional configuration and further comprising deriving at least a portion of the first three-dimensional configuration from the at least one attribute.

6. The method of claim 1, wherein at least a portion of the first data includes at least one datum representing a storage location for at least one parameter representing at least one attribute of the first three-dimensional configuration and further comprising retrieving the at least one parameter from the storage location using the at least one datum.

7. The method of claim 6, further comprising deriving at least a portion of the first three-dimensional configuration from the at least one attribute.

8. The method of claim 1, further comprising incorporation the first input data set into a computer model.

9. The method of claim 1, wherein the first input data set includes transaction data.

10. The method of claim 9, wherein the transaction data includes billing information.

11. The method of claim 1, wherein the first input data set includes identification data.

12. The method of claim 1, wherein the first input data set includes authorization data.

13. The method of claim 1, further comprising presenting a set of preselected objects to a user; and
wherein accepting the first input data set includes accepting a user selection from the set of preselected objects.

14. The method of claim 1, further comprising accepting an identifier input data set including data representing at least one three-dimensional identifier configuration corresponding to an embedded identifier.

15. The method of claim 1, further comprising forming an identifier input data set including data representing at least one three-dimensional identifier configuration corresponding to an embedded identifier.

16. The method of claim 1, wherein the first input data set includes first identification data and the second input data set includes second identification data, the method further comprising forming from the first identification data and the second identification data an identifier input data set including data representing at least one three-dimensional identifier configuration corresponding to an embedded identifier.

17. A method for producing an item data set representing the three-dimensional configuration of an item, the method comprising:
providing a first input data set from a first provider, the first input data set including first data representing at least a first three-dimensional configuration of a first three-dimensional object;
accepting the first input data set;
providing a second input data set from a second provider, the second input data set including second data representing at least a second three-dimensional configuration of a second three-dimensional object;
accepting the second input data set;
adapting the first data input set and the second data input set to be combined to obtain an item data set representing at least a three-dimensional configuration of the item; and
combining the first input data set and the second input data set to obtain the item data set.

18. A method for producing an item, the method comprising:
the method of claim 17 and further comprising using rapid prototyping to produce the item using the item data set.

19. The method of claim 17, wherein at least a portion of the first data directly represents the first three-dimensional configuration.

20. The method of claim 17, wherein at least a portion of the first data includes at least one parameter representing at least one attribute of the first three-dimensional configuration and further comprising deriving at least a portion of the first three-dimensional configuration from the at least one attribute.

21. The method of claim 17, wherein at least a portion of the first data includes at least one datum representing a storage location for at least one parameter representing at least one attribute of the first three-dimensional configuration and further comprising retrieving the at least one parameter from the storage location using the at least one datum and deriving at least a portion of the first three-dimensional configuration from the at least one attribute.

22. The method of claim 17, further comprising incorporation the first input data set into a computer model.

23. The method of claim 17, wherein the first input data set includes transaction data, wherein the transaction data includes billing information.

24. The method of claim 17, wherein the first input data set includes identification data.

25. The method of claim 17, wherein the first input data set includes authorization data.

26. The method of claim 17, further comprising presenting a set of preselected objects to a user; and
wherein accepting the first input data set includes accepting a user selection from the set of preselected objects.

27. The method of claim 17, further comprising accepting an identifier input data set including data representing at least one three-dimensional identifier configuration corresponding to an embedded identifier.

28. The method of claim 17, further comprising forming an identifier input data set including data representing at least one three-dimensional identifier configuration corresponding to an embedded identifier.

29. The method of claim 17, wherein the first input data set includes first identification data and the second input data set includes second identification data, the method further comprising forming from the first identification data and the second identification data an identifier input data set including data representing at least one three-dimensional identifier configuration corresponding to an embedded identifier.

30. A system for producing an item data set representing the three-dimensional configuration of an item, the system comprising:
a processor;
a memory operably coupled to the processor; and
software stored in the memory and adapted
to accept a first input data set, the first input data set including data representing a first three-dimensional configuration of a first three-dimensional object;
to accept a second input data set, the second input data set including data representing a second three-dimensional configuration of a second three-dimensional object;
to adapt one or both of the first data input set and the second data input set to be combined to obtain an item data set representing a three-dimensional configuration of an item, the item including at least one first feature of the first three-dimensional object and at least one second feature of the second three-dimensional object; and
to combine the first input data set and the second input data set to obtain the item data set.

31. A system for producing an item data set representing the three-dimensional configuration of an item, the system comprising:
a processor;
a memory operably coupled to the processor; and
software stored in the memory and adapted
to provide a first input data set from a first provider, the first input data set including first data representing at least a first three-dimensional configuration of a first three-dimensional object;
to accept the first input data set;
to provide a second input data set from a second provider, the second input data set including second data representing at least a second three-dimensional configuration of a second three-dimensional object;
to accept the second input data set;
to adapt the first data input set and the second data input set to be combined to obtain an item data set representing at least a three-dimensional configuration of the item; and
to combine the first input data set and the second input data set to obtain the item data set.

32. A system for producing an item, the system comprising:
a computer including a processor and a memory operably coupled to the processor, the computer programmed
to accept a first input data set, the first input data set including data representing a first three-dimensional configuration of a first three-dimensional object;
to accept a second input data set, the second input data set including data representing a second three-dimensional configuration of a second three-dimensional object;
to adapt one or both of the first data input set and the second data input set to be combined to obtain an item data set representing a three-dimensional configuration of an item, the item including at least one first feature of the first three-dimensional object and at least one second feature of the second three-dimensional object; and
to combine the first input data set and the second input data set to obtain the item data set; and
a fabrication apparatus operably coupled to the computer and programmed to use the item data set to produce the item.

33. The system of claim 32, wherein the fabrication apparatus is a rapid prototyping apparatus.

34. A system for producing an item, the system comprising:
a computer including a processor and a memory operably coupled to the processor, the computer programmed
to provide a first input data set from a first provider, the first input data set including first data representing at least a first three-dimensional configuration of a first three-dimensional object;
to accept the first input data set;
to provide a second input data set from a second provider, the second input data set including second data representing at least a second three-dimensional configuration of a second three-dimensional object;
to accept the second input data set;
to adapt the first data input set and the second data input set to be combined to obtain an item data set representing at least a three-dimensional configuration of the item; and
to combine the first input data set and the second input data set to obtain the item data set; and
a fabrication apparatus operably coupled to the computer and programmed to use the combined data set to produce the item.

35. The system of claim 34, wherein the fabrication apparatus is a rapid prototyping apparatus.
